(19) United States
(12) Patent Application Publication
(10) Pub. No.: US 2025/0258859 A1
(43) Pub. Date: Aug. 14, 2025

(54) CONTENT SELECTION USING METADATA GENERATED UTILIZING ARTIFICIAL INTELLIGENCE MECHANISMS

(71) Applicant: DISH Network Technologies India Private Limited, Bangalore (IN)

(72) Inventor: Kunal Kini K, Bangalore (IN)

(21) Appl. No.: 18/441,835

(22) Filed: Feb. 14, 2024

(51) Int. Cl. G06F 16/435; G06F 16/41

(52) U.S. Cl. CPC G06F 16/435; G06F 16/41

(57) ABSTRACT

Systems and methods for providing content to a user using metadata generated by employing at least one artificial intelligence mechanism. A metadata database is generated for a plurality of content. To generate the database, each corresponding content is analyzed, including: generating first metadata for the corresponding content by employing an artificial intelligence mechanism on user descriptions of the corresponding content; generating second metadata for the corresponding content by employing an artificial intelligence mechanism on the corresponding content; and storing the first metadata and the second metadata in the metadata database and mapped to the corresponding content. Input is received from a user requesting content using the generated metadata database. The metadata database is search for metadata matching the input. And in response to identifying a metadata match, target content is identified from the plurality of content mapped to matched metadata and provided to the user.

### BACKGROUND

Over the past few years, the amount of content that is available to a user has grown substantially. Likewise, users are consuming more and more content. Unfortunately, as the amount of content grows, the ability of the user to find or re-experience, or share, previously consumed content is becoming more difficult. It can be challenging for a user to remember the name of specific content that they have consumed. Without remembering the name of the content, users may rely on other information, such as the actors, genre, or a generic description of the content. But the user may not remember this information, or it may not be sufficient to locate the content. This inability to locate previously consumed content can be exaggerated when the user only sees a portion of the content, such as a specific scene. It is with respect to these and other considerations that the embodiments herein have been made.

### BRIEF SUMMARY

Briefly, embodiments descried herein are directed to dynamically selecting and presenting content to a user based on metadata generated using one or more artificial intelligence mechanisms.

Prior to users attempting to select or access specific content, a metadata database is generated for a plurality of content. Each corresponding content of the plurality of content is analyzed to generate its corresponding metadata for the database. First metadata for the corresponding content is generated by employing a first artificial intelligence mechanism on user descriptions of the corresponding content. Second metadata is generated for the corresponding content by employing a second artificial intelligence mechanism on the corresponding content, such as on scenes of the content or audio portions of the content. The first metadata and the second metadata are then stored in the metadata database and mapped to the corresponding content.

At some time after the metadata database has been generated, input is received from a user. This input may be generalized description or statement about specific content that the user intends to access, but where the user does not know the name of the content or how to access the content. The metadata database is searched for metadata matching the user input. In response to identifying a metadata match in the database for the input, target content mapped to matched metadata is identified and provided to the user.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for employing a metadata database to select and provide content to a user in accordance with embodiments described herein;

FIG. 2 is a context diagram of a non-limiting embodiment of systems for generating and employing a metadata database in accordance with embodiments described herein;

FIG. 3 illustrates a logical flow diagram showing one embodiment of a process for employing a generated metadata database to select and provide content to a user in accordance with embodiments described herein;

FIG. 4 illustrates a logical flow diagram showing one embodiment of a process for employing at least one artificial intelligence mechanism to generate a metadata database in accordance with embodiments described herein; and

FIG. 5 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References herein to the term “user” refer to a person or persons who is or are accessing content. Accordingly, a “user” more generally refers to a person or persons consuming content. Although embodiments described herein utilize user in describing the details of the various embodiments, embodiments are not so limited. For example, in some implementations, the term “user” may be replaced with the term “viewer” throughout the embodiments described herein.

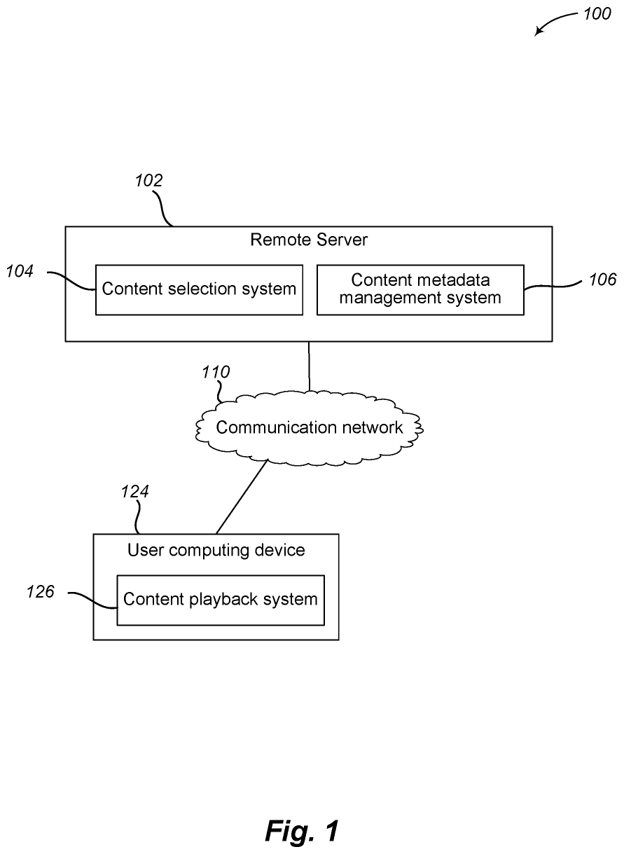

FIG. 1 illustrates a context diagram of an environment 100 for employing a metadata database to select and provide content to a user in accordance with embodiments described herein. Environment 100 includes remote server 102, user computing device 124, and communication network 110. Communication network 110 may be configured to couple various computing devices to transmit content/data from one or more devices to one or more other devices, which enables the user computing device 124 to communicate with the remote server 120. Communication network 110 may include one or more wired or wireless networks.

The remote server 102 is configured to generate a metadata database for a plurality of pieces of audiovisual content and to enable use of that database to provide content to a user of the user computing device 124. The audiovisual content may include movies, sitcoms, reality shows, talk shows, game shows, documentaries, infomercials, news programs, sports programs, songs, audio tracks, albums, podcasts, or the like. The remote server 102 may include a content selection system 104 and a content metadata management system 106. Briefly, the content metadata management system 106 utilizes one or more artificial intelligence mechanisms to analyze a plurality of content to generate metadata for each corresponding content for storage in a metadata database. And briefly, the content selection system 104 receives an input from the user of the user computing device 124 and searches the generated metadata database for metadata that matches the user input. If there is a metadata match, the content selection system 104 provides the mapped or corresponding content for the matched metadata to the user computing device 124.

The user computing device 124 is configured to enable a user to input text or audio to request content from the remote server 102 and to present content to the user based on the metadata that matches the input. Examples of the user computing device 124 may include, but are not limited to, a smartphone, a tablet computer, a set-top box, a cable connection box, a desktop computer, a laptop computer, a television receiver, or other content receivers. In some embodiments, the user computing device 124 may include a display device (not illustrated) for presenting content to a user. Such a display device may be any kind of visual content display device, such as, but not limited to a television, monitor, projector, or other display device. Although FIG. 1 illustrates a single user computing device 124, embodiments are not so limited and a plurality of user computing devices may be utilized or employed.

The user computing device 124 may include a content playback system 126. In some embodiments, the content playback system 126 may communicate with the remote server 102 to receive content selected by the content selection system 104 based on input received from the user of the user computing device 124.

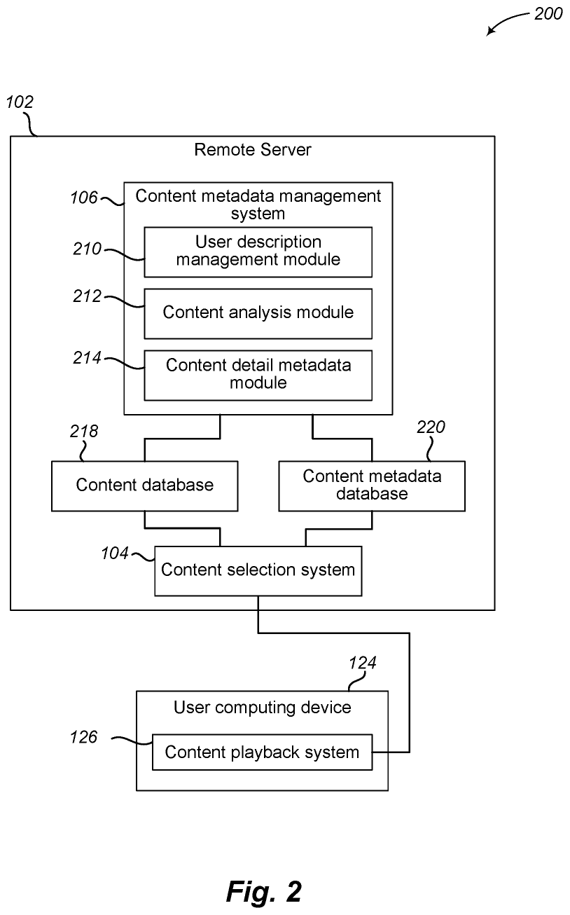

FIG. 2 is a context diagram of a non-limiting embodiment of systems 200 for generating and employing a metadata database to select and provide content to a user in accordance with embodiments described herein. Systems 200 include a remote server 102 and a user computing device 124, similar to environment 100 in FIG. 1.

In various embodiments, the user computing device 124 includes a content playback system 126. The content playback system 126 is configured to receive user input that can be converted into target text for the remote server 102 to search for matching metadata in a metadata database (e.g., content metadata database 220). The content playback system 126 is also configured to receive the target content that maps to the user input from the remote server 102 and display or present the target content to a user of the user computing device 124.

The remote server 102 includes a content selection system 104, a content metadata management system 106, a content database 218, and a content metadata database 220. The content database 218 stores, or enables access to, a plurality of pieces of audiovisual content. And the content metadata database 220 stores metadata for corresponding content and mappings to the corresponding content as generated by the content metadata management system 106. The content metadata database 220 may also be referred to as a metadata database.

The content metadata management system 106 is configured to employ one or more artificial intelligence mechanisms to analyze the content in the content database 218 and to generate the metadata in the content metadata database 220. The content metadata management system 106 may include a user description management module 210, a content analysis module 212, and a content detail metadata module 214. In some embodiments, the content metadata management system 106 may select content from the content database 218 and provide the selected corresponding content to each of the user description management module 210, the content analysis module 212, and the content detail metadata module 214 to generate metadata for the selected corresponding content. In other embodiments, each of the user description management module 210, the content analysis module 212, and the content detail metadata module 214 may individually access the content database 218 to generate metadata for each corresponding content in the content database 218.

The user description management module 210 is configured to obtain user descriptions of the corresponding content in the content database 218 and to employ at least one artificial intelligence mechanism on the obtained user descriptions to generate metadata for the corresponding content. These user descriptions may be user-generated details regarding the corresponding content, such as reviews, blog discussions, articles, etc. The user description management module 210 stores the generated metadata in the content metadata database 220 for the corresponding content.

The content analysis module 212 is configured to analyze the audio portion of the corresponding content, the video portion of the corresponding content, or the closed captioning of the corresponding content to generate metadata for the corresponding content. In some embodiments, the content analysis module 212 may employ at least one artificial intelligence mechanisms on the video portion of the corresponding content to generate the metadata for the corresponding content. In other embodiments, the content analysis module 212 may employ at least one artificial intelligence mechanisms on the audio portion of the corresponding content to generate the metadata for the corresponding content. In yet other embodiments, the content analysis module 212 may employ at least one artificial intelligence mechanisms on the closed captioning of the corresponding content to generate the metadata for the corresponding content. The content analysis module 212 stores the generated metadata in the content metadata database 220 for the corresponding content.

The content detail metadata module 214 is configured to obtain details regarding the corresponding content and then store those details as generated metadata in the content metadata database 220 for the corresponding content.

The content selection system 104 of the remote server is configured to receive user input, such as target text, from the user computing device 124. The content selection system 104 accesses the content metadata database 220 to determine if there is a match between the user input and metadata stored in the metadata database 220. If there is a match, the content selection system 104 identifies the target content that maps to the matched metadata and then accesses the content database 218 to obtain the target content. The content selection system 104 can then provide the target content to the user computing device 124 for presentation to a user.

Although the content selection system 104 and the content metadata management system 106 are illustrated as separate systems, embodiments are not so limited. Rather, a single system or a plurality of systems may be utilized to implement the functionality of the content selection system 104 and the content metadata management system 106. Similarly, although the user description management module 212, the content analysis module 212, and the content detail metadata module 214 are illustrated separately, embodiments are not so limited. Rather, one module or a plurality of modules may be utilized to implement the functionality of the user description management module 212, the content analysis module 212, and the content detail metadata module 214. Moreover, in some embodiments, the content selection system 104 may be employed by the user device 124, such that the user device 124 and the content selection system 104 can communicate with the remote server 102 to access the content metadata database 220 and the content database 218.

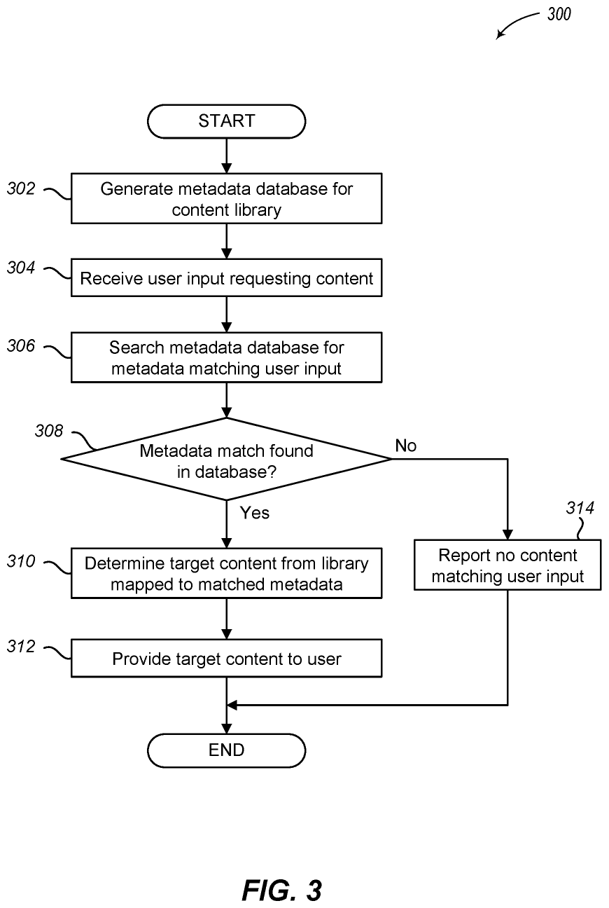

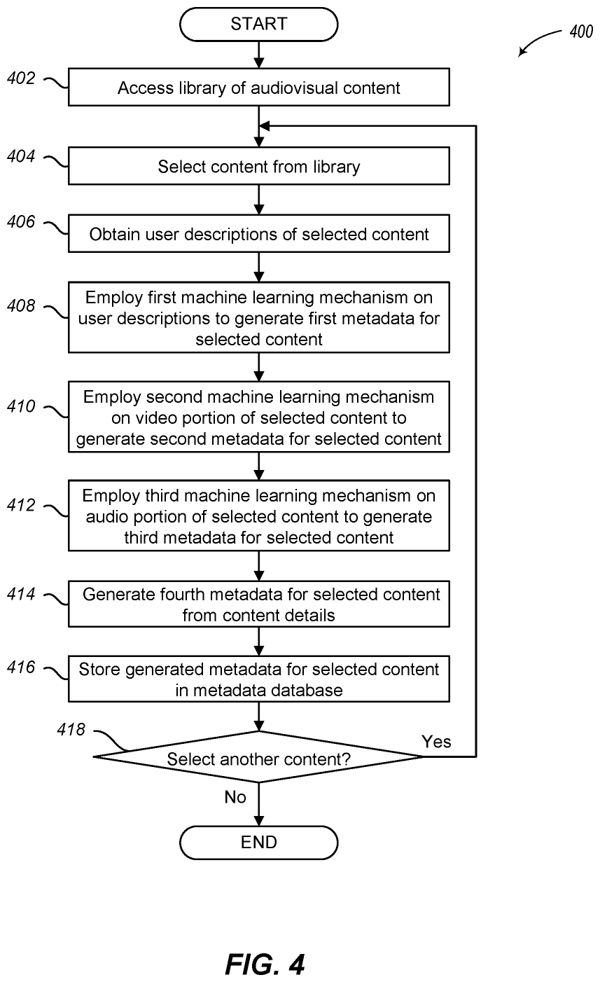

The operation of certain aspects will now be described with respect to FIGS. 3 and 4. Processes 300 and 400 described in conjunction with FIGS. 3 and 4, respectively, may be implemented individually or collectively by one or more processors or executed individually or collectively via circuitry on one or more specialized computing devices, such as remote server 102 or user device 124 in FIG. 1.

FIG. 3 illustrates a logical flow diagram showing one embodiment of a process 300 for employing a generated metadata database to select and provide content to a user in accordance with embodiments described herein.

Process 300 begins, after a start block, at block 302, where a metadata database is generated for an audiovisual content library, which is described in more detail below in conjunction with FIG. 4. Briefly, however, at least one artificial intelligence mechanisms is employed on each corresponding content, descriptions of each corresponding content, or details of each corresponding content to generate metadata for each corresponding content.

Process 300 proceeds after block 302 to block 304, where a user input requesting content is received. This user input includes target text may be a generalized question or statement regarding content without including information regarding the title of the content, where to access the content, or how to access the content. For example, the user input may be “movie where man flies with a red robot suit.” In this particular example, the user is attempting to watch the movie Iron Man from 2008. But in this instance, the user may not know or may not remember the name of the movie. Accordingly, the user input is a generalized statement about what the user knows about the content.

Process 300 continues after block 304 at block 306, where the metadata database is searched for metadata that matches the user input. In various embodiments, the metadata database may be organized or structured so that the database can be efficiently and effectively searched for metadata that matches the user input. In some embodiments, the user input may be parsed into one or more searchable terms that are then used to search the database for matching metadata. These searchable terms may be words, phrases, or text directly from the user input. In other embodiments, one or more artificial intelligence mechanisms may be employed to convert the user input into the searchable terms. In this situation, the searchable terms may be words, phrases, or text that are generated or derived from the user input, which may include terms directly from the user input or terms not included in the user input.

Using the example above where the user input stated, “movie where man flies with a red robot suit,” the system may generate searchable terms including “robot suit,” “red robot suit,” “flying man,” “flying robot,” “flying red robot,” “android person,” and “flying android person.” In this example, some of the searchable terms are directly extracted from the user input, whereas other searchable terms are derived from the user input but not directly extracted from the user input.

Process 300 proceeds after block 306 to decision block 308, where a determination is made whether a metadata match is found in the database. In some embodiments, a match may be an exact or equal one-to-one match between a searchable term and a particular metadata term in the database. In other embodiments, a match may occur when a searchable term is within a similarity threshold with a particular metadata term in the database. For example, in some embodiments, a match may occur if the searchable term “robot suit” is identical to the metadata term “robot suit” in the database. In other embodiments, a match may occur if the searchable term “flying android person” is within a similarity threshold of the metadata term “flying suit person” in the database.

In at least one embodiment, a match is made when a threshold number of searchable terms match metadata terms in the database for a particular content. This threshold number may be a specific number or a percentage of the number of searchable terms. In other embodiments, the type of matching criteria may change based on the number of searchable terms. For example, if the searchable terms include two terms, then both terms may need to exactly match metadata for a particular content for there to be a metadata match; but if the searchable terms include ten terms, then two terms meeting a similarity threshold may indicate a metadata match.

If a metadata match is found in the database for the user input, process 300 flows from decision block 308 to block 310; otherwise, process 300 flows from decision block 308 to block 314.

At block 310, target content from the library is determined for the matched metadata. As described herein, when the metadata database is generated, the database includes a mapping between a particular piece of content and one or more metadata terms for that particular piece of content. Accordingly, the particular content that is mapped to the matched metadata for the user input is determined or selected as the target content in the library.

Process 300 proceeds after block 310 to block 312, where the target content is provided to the user. In some embodiments, the content is displayed to the user. In other embodiments, the content is provided to another device, such as user device 124 for display or presentation to the user. In yet other embodiments, a title, link, or other identifying information of the target content may be provided to the user. In this way, the user can access the target content at a different time, from a different device, or just learn the title of the target content. After block 312, process 300 terminates or otherwise returns to a calling process to perform other actions.

If at decision block 308, the system determines that there is no metadata match found in the database, then process 300 may flow from decision block 308 to block 314. At block 314, a report may be provided to the user indicating that no match was found between the user input and the metadata in the database. After block 314, process 300 terminates or otherwise returns to a calling process to perform other actions.

FIG. 4 illustrates a logical flow diagram showing one embodiment of a process 400 for employing at least one machine learning mechanism to generate a metadata database in accordance with embodiments described herein.

Process 400 begins, after a start block, at block 402, where a library of audiovisual content is accessed. In various embodiments, the library contains a plurality of separate pieces of audiovisual content. The audiovisual content may include movies, television shows, replays of sporting events, replays of concerts, etc. In some embodiments, the library may be stored by or remotely from the computing device performing process 400.

Process 400 proceeds after block 402 to block 404, where a piece of content is selected from the library. In some embodiments, a user may manually select the content. In other embodiments, the content is selected such that each piece of content in the library may be systematically selected and processed in accordance with embodiments described herein.

Process 400 continues after block 404 at block 406, where user descriptions regarding the selected content are obtained. The user descriptions may be reviews, blog posts, articles, or other user-generated information regarding the content. These descriptions may be generated by any number of users or people who have previously consumed the selected content.

Process 400 proceeds after block 406 to block 408, where a first artificial intelligence mechanism is employed on the user descriptions to generate first metadata for the selected content. The first artificial intelligence mechanism may be trained using historical user descriptions and known metadata for specific training content. In some embodiments, the first artificial intelligence mechanism may be tailored for a genre or category of the selected content. The first artificial intelligence mechanism may include one or more machine learning models, artificial neural networks, deep learning, etc. The output of the first artificial intelligence mechanism may include one or more words, phrases, or text that is to be stored as metadata terms in the metadata database for the selected content.

Process 400 continues after block 408 at block 410, where a second artificial intelligence mechanism is employed on a video portion of the selected content to generate second metadata for the selected content. The second artificial intelligence mechanism analyzes one or more scenes in the selected content to determine a computer-generated description of the one or more scenes. These computer-generated descriptions can then be combined or summarized for the selected content. The second artificial intelligence mechanism may be trained using historical user descriptions of known scenes and known metadata for specific training content. In some embodiments, the second artificial intelligence mechanism may be tailored for a genre or category of the selected content. The second artificial intelligence mechanism may include one or more machine learning models, artificial neural networks, deep learning, etc. The output of the second artificial intelligence mechanism may include one or more words, phrases, or text that is to be stored as metadata terms in the metadata database for the selected content.

Process 400 proceeds after block 410 to block 412, where a third artificial intelligence mechanism is employed on an audio portion of the selected content to generate third metadata for the selected content. The third artificial intelligence mechanism analyzes one or more audio clips in the selected content to determine a computer-generated description of the one or more audio clips. In some embodiments, the audio may be first converted to text or the closed captioning may be used as a representation of the audio for input into the third artificial intelligence mechanism. These computer-generated descriptions can then be combined or summarized for the selected content. The third artificial intelligence mechanism may be trained using historical user descriptions of known audio and known metadata for specific training content. In some embodiments, the third artificial intelligence mechanism may be tailored for a genre or category of the selected content. The third artificial intelligence mechanism may include one or more machine learning models, artificial neural networks, deep learning, etc. The output of the third artificial intelligence mechanism may include one or more words, phrases, or text that is to be stored as metadata terms in the metadata database for the selected content.

Process 400 continues after block 412 at block 414, where fourth metadata is generated for the selected content from the content details. The content details may include the title, character names, cast names, length, genre, release date, or other identifying information regarding the selected content.

Process 400 proceeds after block 414 to block 416, where the generated metadata is stored for the selected content in the metadata database. In various embodiments, the metadata database is structurally configured to be searchable using one or more searchable terms from user-provided input, as described herein. In various embodiments, the database includes or stores a mapping between the generated metadata for the selected content and the selected content. In this way, the selected content can be identified as the target content in response to user input that matches the generated metadata for that selected content.

Process 400 proceeds after block 418 to decision block 420, where a determination is made whether to select another piece of content from the content library. In some embodiments, a user may select another piece of content. In other embodiments, another piece of content may be selected if the library of content is being systematically processed and there is an unselected and unprocessed content remaining in the library. If another piece of content is to be selected, process 400 loops to block 404 to select another piece of content and generate metadata for that other piece of content for the metadata database; otherwise, process 400 terminates or otherwise returns to a calling process to perform other actions.

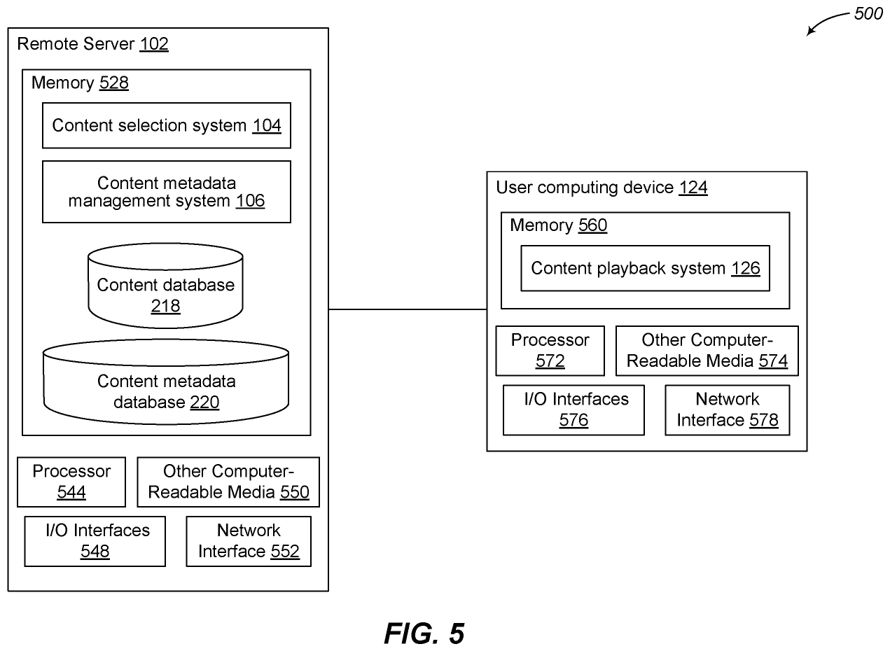

FIG. 5 shows a system diagram that describes one implementation of computing systems for implementing embodiments described herein. System 500 includes remote server 102 and user computing device 124, similar to what is described above in conjunction with FIGS. 1 and 2.

As described herein, the remote server 102 is a computing device that can perform functionality described herein for generating a metadata database using one or more artificial intelligence mechanisms and providing content to a user in response to user input that matches metadata in the database. One or more special purpose computing systems may be used to implement the remote server 102. Accordingly, various embodiments described herein may be implemented in specialized software, hardware, firmware, or in some combination thereof. The remote server 102 includes memory 528, processor 544, network interface 548, input/output (I/O) interfaces 550, and other computer-readable media 552.

Processor 544 includes one or more processors, one or more processing units, programmable logic, circuitry, or one or more other computing components that are configured to perform embodiments described herein or to execute computer instructions to perform embodiments described herein. In some embodiments, a processor system of the remote server 102 may include a single processor 544 that operates individually to perform actions. In other embodiments, a processor system of the remote server 102 may include a plurality of processors 544 that operate to collectively perform actions, such that one or more processors 544 may operate to perform some, but not all, of such actions. Reference herein to “a processor system” of the remote server 102 refers to one or more processors 544 that individually or collectively perform actions. And reference herein to “the processor system” of the remote server 102 refers to 1) a subset or all of the one or more processors 544 comprised by “a processor system” of the remote server 102 and 2) any combination of the one or more processors 544 comprised by “a processor system” of the remote server 102 and one or more other processors 544.

Memory 528 may include one or more various types of non-volatile or volatile storage technologies. Examples of memory 528 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 528 may be utilized to store information, including computer-readable instructions that are utilized by a processor system of one or more processors 544 to perform actions, including at least some embodiments described herein.

Memory 528 may have stored thereon content selection system 104 and content metadata management system 106. The content metadata management system 106 is configured to employ one or more artificial intelligence mechanisms to analyze content stored by content database 218 to generate a metadata database 220. The content selection system 104 is configured to receive user input from user computing device 124, search the metadata database 220 for metadata that matches the user input, and provide target content that maps to the matched metadata to the user computing device 124 for presentation to a user.

Memory 528 may include content database 218 and content metadata database 220. The content database 218 may store a plurality of content, as described herein. And the content metadata database 220 may store metadata for each corresponding content in the content database 218, along with a mapping between the metadata and the corresponding content, as described herein.

Network interface 552 is configured to communicate with other computing devices, such as to receive input from user computing device 124 and to provide target content to the user computing device 124. I/O interfaces 548 may include interfaces for various input or output devices, such as USB interfaces, physical buttons, keyboards, haptic interfaces, tactile interfaces, or the like. Other computer-readable media 550 may include other types of stationary or removable computer-readable media, such as removable flash drives, external hard drives, or the like.

As described herein, the user computing device 124 is a computing device that can perform functionality described herein for receiving user input that contains target text and receiving and presenting content to the user. One or more special purpose computing systems may be used to implement the user computing device 124. Accordingly, various embodiments described herein may be implemented in specialized software, hardware, firmware, or in some combination thereof. The user computing device 124 includes memory 560, processor 572, network interface 578, input/output (I/O) interfaces 576, and other computer-readable media 574.

Processor 572 may be an embodiment of process 544. Accordingly, a processor system of the user computing device 124 may include a single processor 572 that operates individually to perform actions. In other embodiments, a processor system of the user computing device 124 may include a plurality of processors 572 that operate to collectively perform actions, such that one or more processors 544 may operate to perform some, but not all, of such actions. Reference herein to “a processor system” of the user computing device 124 refers to one or more processors 572 that individually or collectively perform actions. And reference herein to “the processor system” of the user computing device 124 refers to 1) a subset or all of the one or more processors 572 comprised by “a processor system” of the user computing device 124 and 2) any combination of the one or more processors 572 comprised by “a processor system” of the user computing device 124 and one or more other processors 572.

Memory 560 may be similar to memory 528. Memory 560 may be utilized to store information, including computer-readable instructions that are utilized by a processor system of one or more processors 572 to perform actions, including at least some embodiments described herein.

Memory 560 may have stored thereon content playback system 126, which is configured to enable a user to provide input and to present content to the user based on the input, as described herein.

Network interface 578 is configured to communicate with other computing devices, such as remote server 102. I/O interfaces 576 may include interfaces for various input or output devices, such as display interface, USB interfaces, physical buttons, keyboards, haptic interfaces, tactile interfaces, or the like. Other computer-readable media 574 may include other types of stationary or removable computer-readable media, such as removable flash drives, external hard drives, or the like.

The following is a summarization of the claims as originally filed.

A method may be summarized as comprising: generating a metadata database for a plurality of content; receiving input from a user; searching the metadata database for metadata matching the input; in response to identifying a metadata match, identifying target content from the plurality of content mapped to matched metadata; and providing the target content to the user. Generating the metadata database for the plurality of content may include: generating first metadata for each corresponding content by employing an artificial intelligence mechanism on user descriptions of the corresponding content; generating second metadata for each corresponding content by employing an artificial intelligence mechanism on the corresponding content; and storing the first metadata and the second metadata in the metadata database and mapped to the corresponding content.

In some embodiments, the details of the corresponding content includes one or more of: title, character name, cast name, length, genre, or release date.

The method may generate the second metadata by: generating the second metadata by employing an artificial intelligence mechanism on a video portion of the corresponding content.

The method may generate the second metadata by employing an artificial intelligence mechanism on each scene of the corresponding content to generate a description of each scene as the second metadata.

The method may generate the second metadata by: generating the second metadata by employing an artificial intelligence mechanism on an audio portion of the corresponding content.

The method may generate the second metadata by: generating a first portion of the second metadata by employing a first artificial intelligence mechanism on an audio portion of the corresponding content; and generating a second portion of the second metadata by employing a second artificial intelligence mechanism on a video portion of the corresponding content.

The method may further comprise: generating third metadata for each corresponding content from details of the corresponding content; and storing the third metadata in the metadata database and mapped to the corresponding content.

The method may search the metadata database for metadata matching the input by: identifying matched metadata in the metadata database in response to the matched metadata meeting a threshold similarity value relative to the input.

The method may generate the first metadata for the corresponding content by: obtaining user-generated descriptions on the corresponding content from a plurality of users; and employing an artificial intelligence mechanism on the user-generated descriptions to generate the first metadata for the corresponding content.

A computing system may be summarized as comprising: at least one memory configured to store computer instructions; and a processor system configured to execute the computer instructions to: generate a metadata database by employing at least one artificial intelligence mechanism for each of a plurality of content to, wherein each content of the plurality of content is mapped to correspondingly generated metadata; receive input from a user; access the metadata database to identify metadata that matches the input; in response to identifying matched metadata, identify target content from the plurality of content mapped to matched metadata; and provide the target content to the user.

The processor system of the computing system may generate the metadata database by being configured to further execute the computer instructions to: generate corresponding metadata for each corresponding content by employing an artificial intelligence mechanism on user descriptions of the corresponding content; and store each corresponding metadata in the metadata database and mapped to the corresponding content.

The processor system of the computing system may generate the metadata database by being configured to further execute the computer instructions to: generate corresponding metadata for each corresponding content by employing an artificial intelligence mechanism on a video component of the corresponding content; and store each corresponding metadata in the metadata database and mapped to the corresponding content.

The processor system of the computing system may generate the metadata database by being configured to further execute the computer instructions to: employ an artificial intelligence mechanism on each scene of each corresponding content to generate a description of each scene as the corresponding metadata of the corresponding content; and store each corresponding metadata in the metadata database and mapped to the corresponding content.

The processor system of the computing system may generate the metadata database by being configured to further execute the computer instructions to: generate corresponding metadata for each corresponding content by employing an artificial intelligence mechanism on an audio component of the corresponding content; and store each corresponding metadata in the metadata database and mapped to the corresponding content.

The processor system of the computing system may generate the metadata database by being configured to further execute the computer instructions to: generate corresponding metadata for each corresponding content by obtaining content details of the corresponding content; and store each corresponding metadata in the metadata database and mapped to the corresponding content. In some embodiments, the details of the corresponding content includes one or more of: title, character name, cast name, length, genre, or release date.

The processor system of the computing system may access the metadata database to identify metadata that matches the input by being configured to further execute the computer instructions to: identify matched metadata in the metadata database in response to the matched metadata meeting a threshold similarity value relative to the input.

A non-transitory computer-readable medium may be summarized as storing computer instructions that, when executed by at least one processor, cause the at least one processor to perform actions, the actions comprising: generating a metadata database for a plurality of content; receiving a request from a user for content; searching the metadata database for metadata matching the request; in response to identifying a metadata match, identifying target content from the plurality of content mapped to matched metadata; and providing the target content to the user in response to the request. Generating the metadata database for a plurality of content may include: generating first metadata for each corresponding content by employing a first artificial intelligence mechanism on user descriptions of the corresponding content; generating second metadata for each corresponding content by employing a second artificial intelligence mechanism on a video component of the corresponding content; generating third metadata for each corresponding content by employing a third artificial intelligence mechanism on an audio component of the corresponding content; generating fourth metadata for each corresponding content from details of the corresponding content; and storing the first, second, third, and fourth metadata in the metadata database and mapped to the corresponding content.

In some embodiments, the details of the corresponding content includes one or more of: title, character name, cast name, length, genre, or release date.

The computer instructions of the non-transitory computer-readable medium, when executed by at least one processor to search the metadata database for metadata matching the request, cause the at least one processor to perform further actions, the further actions comprising: identifying matched metadata in the metadata database in response to the matched metadata meeting a threshold similarity value relative to the request.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
generating a metadata database for a plurality of content, including:
for each corresponding content of the plurality of content:
generating first metadata for the corresponding content by employing a first artificial intelligence mechanism on user descriptions of the corresponding content;
generating second metadata for the corresponding content by employing a second artificial intelligence mechanism on the corresponding content, wherein the second artificial intelligence mechanism is trained separate from the first artificial intelligence mechanism;
mapping the first metadata and the second metadata to the corresponding content; and
storing the first metadata and the second metadata in the metadata database and storing the mapping between the first metadata and the second metadata to the corresponding content;
receiving input from a user;
searching the metadata database for metadata matching the input;
in response to identifying a metadata match, identifying target content from the plurality of content mapped to matched metadata; and
providing the target content to the user.

2. The method of claim 1, wherein generating the second metadata comprises:
generating the second metadata by employing an artificial intelligence mechanism on a video portion of the corresponding content.

3. The method of claim 1, wherein generating the second metadata comprises:
employing an artificial intelligence mechanism on each scene of the corresponding content to generate a description of each scene as the second metadata.

4. The method of claim 1, wherein generating the second metadata comprises:
generating the second metadata by employing an artificial intelligence mechanism on an audio portion of the corresponding content.

5. The method of claim 1, wherein generating the second metadata comprises:
generating a first portion of the second metadata by employing a first artificial intelligence mechanism on an audio portion of the corresponding content; and
generating a second portion of the second metadata by employing a second artificial intelligence mechanism on a video portion of the corresponding content.

6. The method of claim 1, further comprising:
for each corresponding content of the plurality of content:
generating third metadata for the corresponding content from details of the corresponding content; and
storing the third metadata in the metadata database and mapped to the corresponding content.

7. The method of claim 6, wherein the details of the corresponding content includes one or more of: title, character name, cast name, length, genre, or release date.

8. The method of claim 1, wherein searching the metadata database for metadata matching the input comprises:
identifying matched metadata in the metadata database in response to the matched metadata meeting a threshold similarity value relative to the input.

9. The method of claim 1, wherein generating the first metadata for the corresponding content comprises:
obtaining user-generated descriptions on the corresponding content from a plurality of users; and
employing an artificial intelligence mechanism on the user-generated descriptions to generate the first metadata for the corresponding content.

10. A computing system, comprising:
at least one memory configured to store computer instructions; and
a processor system configured to execute the computer instructions to:
generate a metadata database by employing a plurality of artificial intelligence mechanisms for each of a plurality of content to generate metadata, wherein each artificial intelligence mechanism of the plurality of artificial intelligence mechanisms is trained to generate different types of metadata, and wherein each content of the plurality of content is mapped to correspondingly generated metadata;
receive input from a user;
access the metadata database to identify metadata that matches the input;
in response to identifying matched metadata, identify target content from the plurality of content mapped to matched metadata; and
provide the target content to the user.

11. The computing system of claim 10, wherein the processor system generates the metadata database by being configured to further execute the computer instructions to:
generate corresponding metadata for each corresponding content by employing an artificial intelligence mechanism on user descriptions of the corresponding content; and
store each corresponding metadata in the metadata database and mapped to the corresponding content.

12. The computing system of claim 10, wherein the processor system generates the metadata database by being configured to further execute the computer instructions to:
generate corresponding metadata for each corresponding content by employing an artificial intelligence mechanism on a video component of the corresponding content; and
store each corresponding metadata in the metadata database and mapped to the corresponding content.

13. The computing system of claim 10, wherein the processor system generates the metadata database by being configured to further execute the computer instructions to:
employ an artificial intelligence mechanism on each scene of each corresponding content to generate a description of each scene as the corresponding metadata of the corresponding content; and
store each corresponding metadata in the metadata database and mapped to the corresponding content.

14. The computing system of claim 10, wherein the processor system generates the metadata database by being configured to further execute the computer instructions to:
generate corresponding metadata for each corresponding content by employing an artificial intelligence mechanism on an audio component of the corresponding content; and
store each corresponding metadata in the metadata database and mapped to the corresponding content.

15. The computing system of claim 10, wherein the processor system generates the metadata database by being configured to further execute the computer instructions to:
generate corresponding metadata for each corresponding content by obtaining content details of the corresponding content; and
store each corresponding metadata in the metadata database and mapped to the corresponding content.

16. The computing system of claim 15, wherein the details of the corresponding content includes one or more of: title, character name, cast name, length, genre, or release date.

17. The computing system of claim 10, wherein the processor system accesses the metadata database to identify metadata that matches the input by being configured to further execute the computer instructions to:
identify matched metadata in the metadata database in response to the matched metadata meeting a threshold similarity value relative to the input.

18. A non-transitory computer-readable medium storing computer instructions that, when executed by at least one processor, cause the at least one processor to perform actions, the actions comprising:
generating a metadata database for a plurality of content, including:
for each corresponding content of the plurality of content:
generating first metadata for the corresponding content by employing a first artificial intelligence mechanism on user descriptions of the corresponding content;
generating second metadata for the corresponding content by employing a second artificial intelligence mechanism on a video component of the corresponding content;
generating third metadata for the corresponding content by employing a third artificial intelligence mechanism on an audio component of the corresponding content;
generating fourth metadata for the corresponding content from details of the corresponding content; and
storing the first, second, third, and fourth metadata in the metadata database and mapped to the corresponding content;
receiving a request from a user for content;
searching the metadata database for metadata matching the request;
in response to identifying a metadata match, identifying target content from the plurality of content mapped to matched metadata; and
providing the target content to the user in response to the request.

19. The non-transitory computer-readable medium of claim 18, wherein the details of the corresponding content includes one or more of: title, character name, cast name, length, genre, or release date.

20. The non-transitory computer-readable medium of claim 18, wherein the computer instructions, when executed by at least one processor to search the metadata database for metadata matching the request, cause the at least one processor to perform further actions, the further actions comprising:
identifying matched metadata in the metadata database in response to the matched metadata meeting a threshold similarity value relative to the request.
